(19) United States
(12) Patent Application Publication
(10) Pub. No.: US 2021/0272588 A1
(43) Pub. Date: Sep. 2, 2021

(54) MAGNETIC DISK DEVICE AND WRITE RETRY PROCESSING METHOD

(71) Applicants: KABUSHIKI KAISHA TOSHIBA, Tokyo (JP); TOSHIBA ELECTRONIC DEVICES & STORAGE CORPORATION, Tokyo (JP)

(72) Inventor: Naoaki KAWANA, Fujisawa Kanagawa (JP)

(21) Appl. No.: 16/936,103

(22) Filed: Jul. 22, 2020

(30) Foreign Application Priority Data
Feb. 28, 2020 (JP) 2020-033396

(51) Int. Cl. G11B 5/02; G11B 5/265; G11B 5/55; G11B 19/04; G11B 20/18

(52) U.S. Cl. CPC G11B 5/02; G11B 5/2655; G11B 2020/183; G11B 19/04; G11B 20/1816; G11B 5/5526

(57) ABSTRACT

A magnetic disk device includes a disk has a first area in which data is written by first recording method such that a plurality of tracks are spaced from each other, and a second area written with data by second recording method such that adjacent tracks partially overlap, a head, and a controller. The controller is configured to control the head to write data to a track of the first or second area by the first or second recording method, and perform a retry operation when the data has not been written to the track successfully, and repeat the retry operation until the data is written successfully up to a predetermined number of times. When data is being written to a track of the first area, the retry operation is repeated up to a different number of times depending on a location of the track within the first area.

### CROSS-REFERENCE TO RELATED APPLICATION

This application is based upon and claims the benefit of priority from Japanese Patent Application No. 2020-033396, filed Feb. 28, 2020, the entire contents of which are incorporated here by reference.

### FIELD

Embodiments described herein relate generally to a magnetic disk device and a write retry processing method.

### BACKGROUND

In recent years, techniques for increasing recording density of magnetic disk drives have been developed. One of such techniques is shingled write magnetic recording (SMR) or shingled write recording (SWR) in which data is written such that tracks that are adjacent in a radial direction of a disk partially overlap each other. There is a known magnetic disk device that can switch between a SMR-type recording and a conventional magnetic recording (CMR) (a non-SMR-type) in which a plurality of tracks are written at predetermined intervals along the a radial direction of a disk.

### BRIEF DESCRIPTION OF THE DRAWINGS

FIG. 1 is a block diagram illustrating a magnetic disk device according to a first embodiment.

FIG. 2 is a schematic diagram illustrating a disk according to a first embodiment.

FIG. 3 is a schematic diagram illustrating normal recording processing.

FIG. 4 is a schematic diagram illustrating shingled recording processing.

FIG. 5 is a schematic diagram illustrating an arrangement of a normal recording band area and a shingled recording band area.

FIG. 6 is a schematic diagram illustrating a method for setting a limited track.

FIG. 7 is a diagram illustrating a table for storing the number of retries in each track.

FIG. 8 is a flowchart of write retry processing according to a first embodiment.

FIG. 9 is a schematic diagram illustrating a normal recording band area and a shingled recording band area according to a modification example.

### DETAILED DESCRIPTION

Embodiments provide a magnetic disk device and a write retry processing method capable of improving the performance of write processing.

In general, according to one embodiment, a magnetic disk device includes a disk that includes a first area in which data is written by first recording technique such that a plurality of tracks are separated from each other, and a second area and in which data is written by a second recording technique such that adjacent tracks partially overlap, a head, and a controller. The controller is configured to control the head to write data to a track of the first or the second area by the first or the second recording technique, and perform a retry operation when the data has not been written to the track successfully, and repeat the retry operation until the data is written successfully up to a predetermined number of times. When data is being written to a track of the first area, the retry operation is repeated up to a different number of times depending on a location of the track within the first area.

Hereinafter, certain example embodiments will be described with reference to drawings. The drawings are merely examples and do not limit the scope of the present disclosure.

### First Embodiment

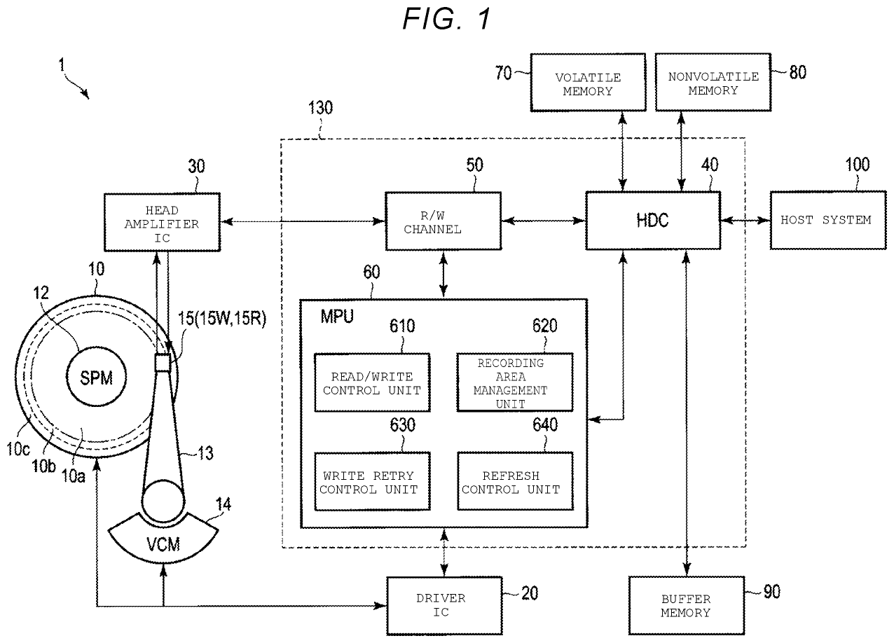

FIG. 1 is a block diagram illustrating a magnetic disk device 1 according to a first embodiment. A magnetic disk device 1 includes a head disk assembly (HDA) described later, a driver IC 20, a head amplifier integrated circuit (hereinafter, referred to as a “head amplifier IC” or “preamplifier”) 30, a volatile memory 70, a nonvolatile memory 80, a buffer memory (hereinafter, referred to as a “buffer”) 90, and a system controller 130 which is a one-chip integrated circuit. The magnetic disk device 1 is connected to a host system (hereinafter, simply referred to as a host) 100.

The HDA includes a magnetic disk 10 (also referred to as a disk 10), a spindle motor (SPM) 12, an arm 13 on which a head 15 is mounted, and a voice coil motor (VCM) 14. The disk 10 is attached to the SPM 12 and is rotated by the SPM 12. The arm 13 and the VCM 14 make up an actuator. The actuator controls the movement of the head 15 mounted on the arm 13 to a particular position on the disk 10 by driving the VCM 14. Two or more disks 10 and heads 15 may be provided.

The disk 10 includes a user data area 10a available for the user, a media cache 10b (sometimes referred to as a media cache area) that temporarily stores data (or command) transferred from a host or the like before writing the data in a particular area of the user data area 10a, and a system area 10c for writing information necessary for system management. A direction from the inner circumference to the outer circumference of the disk 10, and likewise a direction from the outer circumference to the inner circumference of the disk 10 is referred to as a radial direction. In this context, the (radial) direction from the inner circumference to the outer circumference is referred to as an outward direction, and a (radial) direction from the outer circumference to the inner circumference is referred to as an inward direction. The direction orthogonal to the radial direction of the disk 10 is referred to a circumferential direction. The circumferential direction corresponds to a direction along the circumference of the disk 10. Further, a certain position along the radial direction of the disk 10 may be referred to as a radial position, and a certain position along the circumferential direction of the disk 10 may be referred to as a circumferential position. The radial position and the circumferential position may be collectively referred to as a position.

The disk 10 is divided into a plurality of areas (which may be referred to as zones) for predetermined ranges in the radial direction. A zone can be divided into a plurality of sub-areas (which may be referred to as band areas) in the radial direction. Each band area includes a plurality of tracks. A track includes a plurality of sectors. Furthermore, an area obtained by dividing the disk 10 in the radial direction may be referred to as a radial area. Such a radial area includes a zone, a band area, a track, and the like.

The term “track” is used in this disclosure to indicate: one of a plurality of areas divided at points along the radial direction of the disk 10, a path of the head 15 at a predetermined radial position, data extending in the circumferential direction of the disk 10, one round of data written to a track at a certain radial position, data written to the track, a part of data written to the track, or the like. The term “sector” is used in this disclosure to indicate one of a plurality of areas obtained by dividing a track at points along the circumferential direction, data written in a predetermined position on the disk 10, data written in a sector, or the like.

The “track written on the disk 10” may be referred to as a “write track”, and the “track read from the disk 10” may be referred to as a “read track”. The “write track” may be simply referred to as a “track”, the “read track” may be simply referred to as a “track”, or the “write track” and “read track” may be collectively simply referred to as a “track”. The “width of a track in the radial direction” may be referred to as a “track width”. The “width of the write track in the radial direction” may be referred to as a “write track width”, and the “width of the read track in the radial direction” may be referred to as a “read track width”. The “write track width” may be simply referred to as a “track width”, the “read track width” may be simply referred to as a “track width”, and the “write track width and read track width” may be collectively simply referred to as a “track width”. The “path passing through the center position of a track width in a predetermined track” is referred to as a “track center”. The “path passing through the center position of a write track width in a predetermined write track” may be referred to as a “write track center”, and the “path passing through the center position of a read track width of a read track” may be referred to as a “read track center”. The “write track center” may be simply referred to as a “track center”, the “read track center” may be simply referred to as a “track center”, and the “write track center and read track center” may be collectively simply referred to as a “track center”.

The head 15 has a slider and includes a write head 15W and a read head 15R mounted on the slider. The write head 15W writes data to the disk 10. The read head 15R reads data from the disk 10. The “write head 15W” may be simply referred to as the “head 15”, the “read head 15R” may be simply referred to as the “head 15”, and the “write head 15W and read head 15R” may be collectively referred to as the “head 15”. The “central part of the head 15” may be referred to as the “head 15”, the “central part of the write head 15W” may be referred to as the “write head 15W”, and the “central part of the read head 15R” may be referred to as the “read head 15R”. The “central part of the write head 15W” may be simply referred to as the “head 15”, and the “central part of the read head 15R” may be simply referred to as the “head 15”. “Positioning the central part of the head 15 at the track center of a particular track” may be expressed as “positioning the head 15 on a particular track”, “placing the head 15 on a particular track”, or “positioning the head 15 on a particular track”.

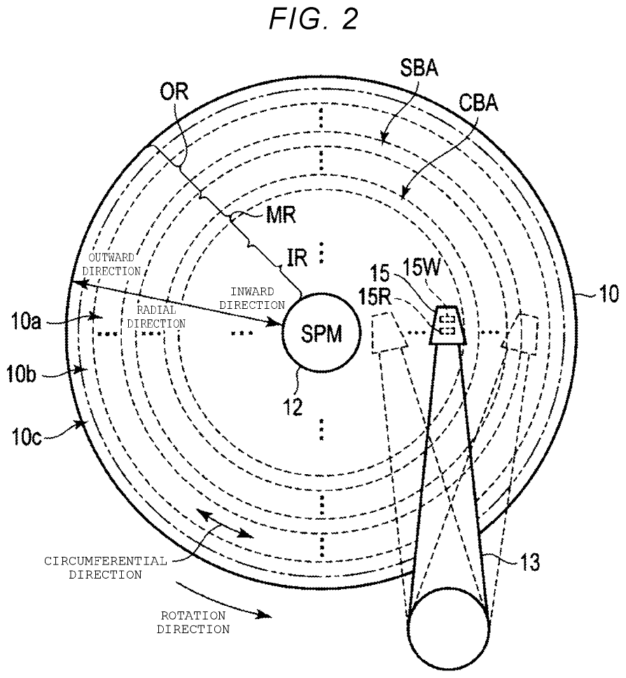

FIG. 2 is a schematic diagram illustrating the disk 10 according to the present embodiment. As illustrated in FIG. 2, the direction in which the disk 10 rotates in the circumferential direction is referred to as a rotation direction. In the example illustrated in FIG. 2, the rotation direction is counterclockwise, but may be reverse (e.g., clockwise). In FIG. 2, the disk 10 is divided into an inner circumferential area IR located inward, an outer circumferential area OR located outward, and a middle circumferential area MR located between the inner circumferential area IR and the outer circumferential area OR.

FIG. 2 illustrates the media cache 10b. In FIG. 2, the media cache 10b and the system area 10c are located in the outer circumferential area OR. In the example illustrated in FIG. 2, the system area 10c is located at the outermost circumference of the disk 10. The media cache 10b is arranged adjacent to the inside of the system area 10c. Here, the term “adjacent” is used for not only data, objects, areas, spaces, and the like being arranged side by side but also the ones being arranged at predetermined intervals. The user data area 10a is arranged adjacent to the media cache 10b in the inward direction. The media cache 10b may be located in the inner circumferential area IR or the middle circumferential area MR. Further, the media cache 10b may be located dispersedly in the outer circumferential area OR, the middle circumferential area MR, and the inner circumferential area IR.

The user data area 10a of the disk 10 includes an area (which may be referred to as a normal recording area) for writing data in a normal recording (i.e., CMR) format in which tracks adjacent to a particular track (which may be referred to as adjacent tracks) are written at predetermined intervals in the radial direction from the particular track. Additionally, the user data area 10a includes an area (which may be referred to as a shingled recording area) for writing data in a shingled recording (i.e., SMR or SWR) format in which a track to be written next overlaps a part of an adjacent track in the radial direction.

Hereinafter, “writing data in a normal recording type” may be simply referred to as “normal recording” or “normal recording processing”, and “writing data in a shingled recording type” may be simply referred to as “shingled recording” or “shingled recording processing”. Further, write processing other than the “normal recording processing” may be referred to as “shingled recording processing”. The entire area of the user data area 10a may be a normal recording area or a shingled recording area.

Each of the normal recording area and the shingled recording area includes at least one band area. Hereinafter, the “band area in a normal recording area” may be referred to as a “normal recording band area”, and the “band area in a shingled recording area” may be referred to as a “shingled recording band area”. In the example illustrated in FIG. 2, a normal recording band area CBA and a shingled recording band area SBA are arranged in the user data area 10a. The normal recording band area includes a plurality of tracks. The normal recording band area may include only one track. The shingled recording band area includes a plurality of overlapping tracks. The shingled recording band area may include only one track.

Hereinafter, the “normal recording band area” is simply referred to as a “band area”, the “shingled recording band area” is simply referred to as a “band area”, and the “normal recording band area” and the “shingled recording band area” are referred to as a “band area.” In the user data area 10a, at least one shingled recording band area SBA may be arranged between a plurality of normal recording band areas CBA arranged at intervals in the radial direction, or at least one normal recording band area CBA may be arranged between a plurality of shingled recording band areas SBA arranged at intervals in the radial direction.

The driver IC 20 drives the SPM 12 and the VCM 14 under the control of the system controller 130 (or an MPU 60 described later).

The head amplifier IC (or the preamplifier) 30 includes a read amplifier, a write driver, and the like. The read amplifier amplifies a read signal read from the disk 10 and outputs the amplified signal to the system controller 130 (more specifically, a read/write (R/W) channel 50). The write driver outputs a write current to the head 15 corresponding to the signal output from the R/W channel 50.

The volatile memory 70 is a semiconductor memory in which stored data is lost when power supply is cut off. The volatile memory 70 stores data and the like necessary for processing in each unit of the magnetic disk device 1. The volatile memory 70 is, for example, a dynamic random access memory (DRAM) or a synchronous dynamic random access memory (SDRAM).

The nonvolatile memory 80 is a semiconductor memory that maintains stored data even when power supply is cut off. The nonvolatile memory 80 is, for example, a NOR or NAND flash read only memory (“FROM”).

The buffer memory 90 is a semiconductor memory for temporarily storing data and the like transmitted and received between the magnetic disk device 1 and the host 100. The buffer memory 90 may be configured integrally with the volatile memory 70. The buffer memory 90 is, for example, a DRAM, static random access memory (SRAM), SDRAM, ferroelectric random access memory (FeRAM), magnetoresistive random access memory (MRAM), or the like.

The system controller 130 is, for example, a large-scale integrated circuit (LSI) called a system-on-a-chip (SoC) in which a plurality of elements are integrated on a single chip. The system controller 130 includes a hard disk controller (HDC) 40, the read/write (R/W) channel 50, and a microprocessor or a micro-processing unit (MPU) 60. The HDC 40, the R/W channel 50, and the MPU 60 are electrically connected to each other. The system controller 130 is electrically connected to, for example, the driver IC 20, the head amplifier IC 30, the volatile memory 70, the nonvolatile memory 80, the buffer memory 90, the host system 100, and the like.

The HDC 40 controls data transfer between the host 100 and the R/W channel 50 according to an instruction from the MPU 60 described later. The HDC 40 is electrically connected to, for example, the volatile memory 70, the nonvolatile memory 80, the buffer memory 90, and the like.

The R/W channel 50 executes signal processing of read data and write data according to an instruction from the MPU 60. The R/W channel 50 has a circuit or function for modulating write data. The R/W channel 50 has a circuit or a function for measuring the signal quality of the read data. The R/W channel 50 is electrically connected to, for example, the head amplifier IC 30 or the like.

The MPU 60 is a main controller that controls each unit of the magnetic disk device 1. The MPU 60 controls the VCM 14 via the driver IC 20 to execute positioning of the head 15. The MPU 60 controls an operation of writing data to the disk 10 and selects a storage destination of the write data transferred from the host 100. The MPU 60 controls an operation of reading data from the disk 10 and controls the processing of read data transferred from the disk 10 to the host 100. The MPU 60 manages an area for recording data. The MPU 60 is connected to each unit of the magnetic disk device 1. The MPU 60 is electrically connected to, for example, the driver IC 20, the HDC 40, the R/W channel 50, and the like.

The MPU 60 operates as a read/write control unit 610, a recording area management unit 620, a write retry control unit 630, and a refresh control unit 640. For example, the MPU 60 executes firmware to perform functions of the read/write control unit 610, the recording area management unit 620, the write retry control unit 630, the refresh control unit 640, and the like on the firmware. Alternatively, one or more of those functions may be performed by one or more circuits.

The read/write control unit 610 controls data read processing and data write processing according to a command or the like from the host 100. The read/write control unit 610 controls the VCM 14 via the driver IC 20, positions the head 15 at a particular radial position on the disk 10, and executes read processing or write processing.

The read/write control unit 610 selects and executes normal recording processing and shingled recording processing according to a command from the host 100 or the like. In other words, the read/write control unit 610 selectively executes normal recording processing or shingled recording processing according to a command from the host 100 or the like. The read/write control unit 610 executes normal recording processing in a normal recording area and executes shingled recording processing in a shingled recording area. The read/write control unit 610 writes data randomly or sequentially in the normal recording processing. The read/write control unit 610 sequentially writes data in the shingled recording processing. The read/write control unit 610 may execute only the normal recording processing, or may execute only the shingled recording processing.

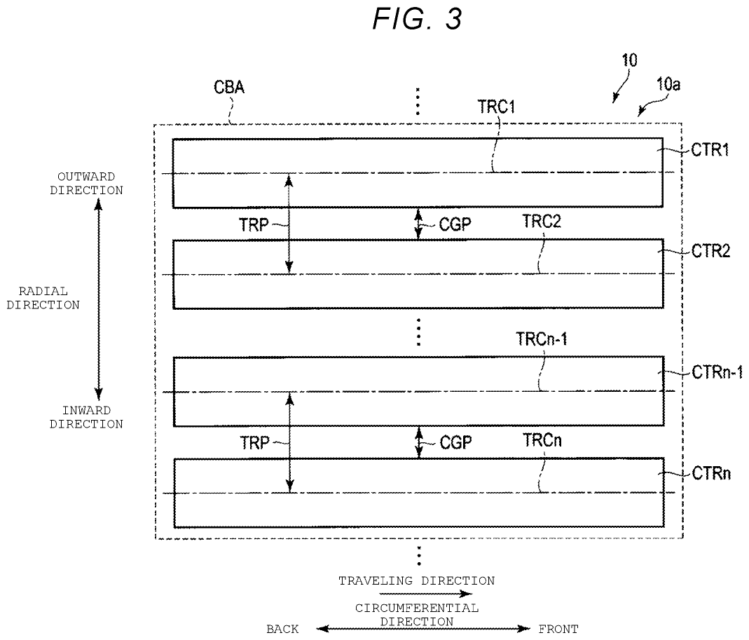

FIG. 3 is a schematic diagram illustrating the normal recording processing. As illustrated in FIG. 3, a direction in which data is sequentially written and read in the radial direction is referred to as a forward direction. In FIG. 3, the forward direction is an inward direction. The forward direction may be an outward direction. As illustrated in FIG. 3, a direction in which the head 15 advances with respect to the disk 10 in the circumferential direction, that is, a direction in which reading/writing is executed, may be referred to as a traveling direction.

FIG. 3 illustrates the normal recording band area CBA. In the example illustrated in FIG. 3, the normal recording band area CBA includes a track CTR1, a track CTR2, . . . , a track CTRn-1, and a track CTRn. FIG. 3 illustrates a track center TRC1 of the track CTR1, a track center TRC2 of the track CTR2, . . . , a track center TRCn-1 of the track CTRn-1, and a track center TRCn of the track CTRn. The tracks CTR1 to CTRn are each arranged at a track pitch TRP in the radial direction. The track pitch corresponds to, for example, a radial distance between track centers of two adjacent tracks. For example, the track center TRC1 of the track CTR1 and the track center TRC2 of the track CTR2 are separated by the track pitch TRP in the radial direction. Further, for example, the track center TRCn-1 of the track CTRn-1 and the track center TRCn of the track CTRn are separated by the track pitch TRP in the radial direction. The tracks CTR1 to CTRn may be arranged at different track pitches in the radial direction.

The tracks CTR1 to CTRn are arranged with a gap CGP in the radial direction. For example, the tracks TRC1 and TRC2 are separated by the gap CGP, and the tracks TRCn-1 and TRCn are separated by the gap CGP. The tracks CTR1 to CTRn may be arranged with different gaps. In FIG. 3, for convenience of description, each track is illustrated as a rectangular shape extending in the circumferential direction with a predetermined track width, but is actually curved along the circumferential direction. Further, each track may have a wavy shape that varies in the radial direction and extends in the circumferential direction.

In the example illustrated in FIG. 3, the read/write control unit 610 positions the head 15 at the track center TRC1 in the normal recording band area CBA of the user data area 10a, and records the track CTR1 by the normal recording (non-SMR) method. In the normal recording band area CBA, the read/write control unit 610 positions the head 15 at the track center TRC2 which is separated from the track center TRC1 of the track CTR1 inward by the track pitch TRP, and records the track CTR2 by the normal recording (non-SMR) method. The read/write control unit 610 positions the head 15 at the track center TRCn in the normal recording band area CBA of the user data area 10a, which is separated at the track pitch TRP inward from the track center TRCn-1 of the track CTRn-1, and records the track CTRn by the normal (non-SMR) recording. The read/write control unit 610 may sequentially perform normal recording on the tracks CTR1, CTR2, . . . , CTRn-1, and CTRn in the normal recording band area CBA of the user data area 10a, or may randomly perform normal recording in a predetermined sector of each of the tracks CTR1, CTR2, . . . , CTRn-1, and CTRn.

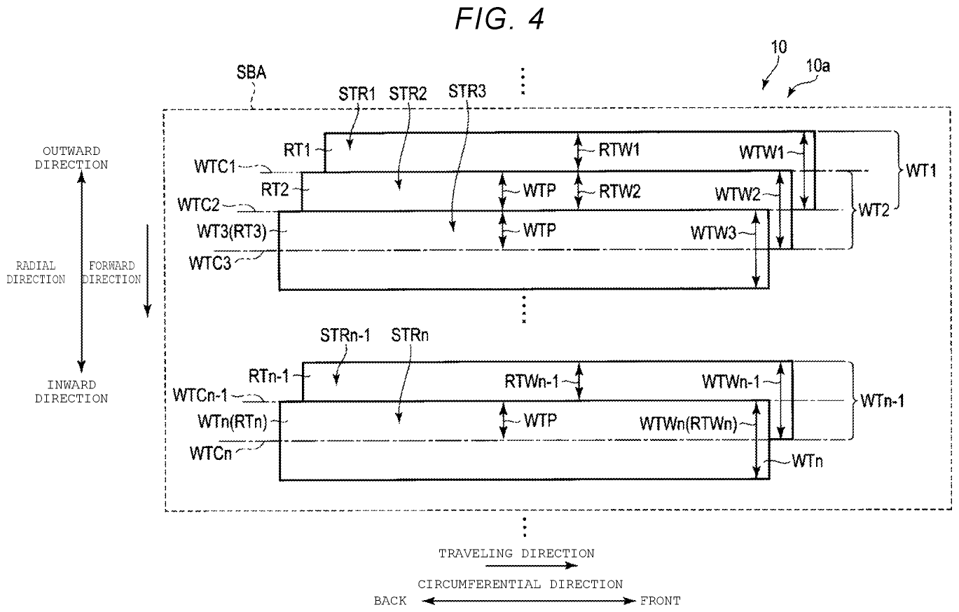

FIG. 4 is a schematic diagram illustrating the shingled recording processing. FIG. 4 illustrates the shingled recording band area SBA. In the example illustrated in FIG. 4, the shingled recording band area SBA includes tracks STR1, STR2, STR3, . . . , STRn-1, and STRn that partially overlap in the radial direction in the forward direction. The track STR1 written on the disk 10 by the write head 15W may be referred to as a write track WT1, the track STR2 written on the disk 10 by the write head 15W may be referred to as a write track WT2, the track STR3 written on the disk 10 by the write head 15W may be referred to as a write track WT3, the track STRn-1 written to the disk 10 by the write head 15W may be referred to as a write track WTn-1, and the track STRn written to the disk 10 by the write head 15W may be referred to as a write track WTn.

FIG. 4 illustrates a track center WTC1 of the write track WT1 (the track STR1), a track center WTC2 of the write track WT2 (the track STR2), a track center WTC3 of the write track WT3 (i.e., the track STR3), . . . , a track center WTCn-1 of the write track WTn-1 (the track STRn-1), and a track center WTCn of the write track WTn (the track STRn). The write tracks WT1 to write track WTn are each arranged at a track pitch WTP in the radial direction. The track pitch WTP is smaller than the track pitch TRP, for example.

For example, the track center WTC1 of the write track WT1 and the track center WTC2 of the write track WT2 are separated by the track pitch WTP in the radial direction. For example, the track center WTC2 of the write track WT2 and the track center WTC3 of the write track WT3 are separated by the track pitch WTP in the radial direction. Further, for example, the track center WTCn-1 of the write track WTn-1 and the track center WTCn of the write track WTn are separated by the track pitch WTP in the radial direction. The write tracks WT1 to WTn may be arranged at different track pitches in the radial direction. Further, the write tracks WT1 to WTn are written so as to overlap a part of a previous track in the radial direction. The area of the remaining write track WT1 other than the area where the write track WT2 overlaps is referred to as a read track RT1, and the area of the remaining write track WT2 other than the area where the write track WT3 overlaps is referred to as a read track RT2, the area of the remaining write track WTn-1 other than the area where the write track WTn overlaps is referred to as a read track RTn-1. In addition, the write track WTn that is written last when data is sequentially written in the forward direction in the shingled band area SBA and does not overlap other write tracks may be referred to as a read track RTn (WTn). FIG. 4 illustrates a read track width RTW1 of the read track RT1, a read track width RTW2 of the read track RT2, . . . , a read track width RTWn-1 of the read track RTn-1, and a read track width RTWn of the read track RTn. In FIG. 4, the read track width RTWn of the read track RTn is the same as the write track width WTWn of the write track WTn. Hereinafter, in the shingled recording processing, the term “track” may be used for “write track”, the term “track” may be used for “read track”, and the term “track” may be used to mean “write track” and “read track”. In FIG. 4, for convenience of description, each track is illustrated as a rectangular shape extending in the circumferential direction with a predetermined track width, but is actually curved along the circumferential direction. Further, each track may have a wavy shape that varies in the radial direction and extends in the circumferential direction.

In the example illustrated in FIG. 4, the read/write control unit 610 sequentially performs shingled recording in the forward direction on the write track WT1 of a write track width WTW1, the write track WT2 having a write track width WTW2, the write track WT3 having a write track width WTW3, . . . , the write track WTn-1 having a write track width WTWn-1, and the write track WTn having a write track width WTWn in the shingled recording band area SBA of the user data area 10a in the stated order. In other words, the read/write control unit 610 writes the track STR1 (the write track WT1), the track STR2 (the write track WT2), the track STR3 (the write track WT3), . . . , the track STRn-1 (the write track WTn-1), and the track STRn (the write track WTn) in the shingled recording band area SBA of the user data area 10a in the forward direction in the stated order.

In the example illustrated in FIG. 4, the read/write control unit 610 writes the write track WT1 by positioning the head 15 at the track center WTC1 in the shingled recording band area SBA of the user data area 10a. The read/write control unit 610 positions the head 15 at the track center WTC2 which is separated from the track center WTC1 of the write track WT1 by the track pitch WTP in the forward direction in the shingled recording band area SBA, and performs shingled recording of the write track WT2 on the write track WT1. The read/write control unit 610 positions the head 15 at the track center WTC3 which is separated from the track center WTC2 of the write track WT2 by the track pitch WTP in the forward direction in the shingled recording band area SBA, and performs shingled recording of the write track WT3 on the write track WT2. The read/write control unit 610 positions the head 15 at the track center WTCn which is separated from the track center WTCn-1 of the write track WTn-1 by the track pitch WTP in the forward direction in the shingled recording band area SBA, and performs shingled recording of the write track WTn on the write track WTn-1.

The recording area management unit 620 manages a recording area of the disk 10 (hereinafter, also simply referred to as the disk 10) according to an instruction from the host 100 or the like. The recording area management unit 620 sets a normal recording area and a shingled recording area in the user data area 10a of the disk 10 according to an instruction from the host 100 or the like. The recording area management unit 620 sets a normal recording area for each normal recording band area CBA in the user data area 10a, for example. In other words, the recording area management unit 620 sets, for example, the normal recording band area CBA in the user data area 10a. The recording area management unit 620 sets a shingled recording area for each shingled recording band area SBA in the user data area 10a, for example. In other words, the recording area management unit 620 sets, for example, the shingled recording band area SBA in the user data area 10a. The recording area management unit 620 can change the normal recording band area CBA to the shingled recording band area SBA according to an instruction from the host 100 or the like. Furthermore, the recording area management unit 620 can change the shingled recording band area SBA to the normal recording band area CBA according to an instruction from the host 100 or the like.

The recording area management unit 620 sets a gap between radially adjacent band areas so that two adjacent band areas are separated by the gap. The recording area management unit 620 sets a predetermined gap (hereinafter, this may be referred to as a normal recording band gap) between two normal recording band areas that are adjacent to one another in the radial direction in the user data area 10a so that two adjacent normal recording band areas are separated by a normal recording band gap in the radial direction.

Additionally, the recording area management unit 620 sets a predetermined gap (hereinafter, this may be referred to as a shingled recording band gap) between two shingled recording band areas that are adjacent to one another in the radial direction in the user data area 10a so that two adjacent shingled recording band areas are separated by a shingled recording band gap in the radial direction with. The recording area management unit 620 also sets a predetermined gap (hereinafter, this may be referred to as a shingled/normal recording band gap) between a normal recording band area and a shingled recording band area that are adjacent to one another in the radial direction in the user data area 10a so that a normal recording band area and a shingled recording band area are separated by a shingled/normal recording band gap in the radial direction.

For example, the shingled/normal recording band gap is larger than the normal recording band gap and the shingled recording band gap. The shingled/normal recording band gap is typically wider than at least the normal recording band gap. However, in some examples, the shingled/normal recording band gap may be substantially the same width as the normal recording band gap, or may be narrower than the normal recording band gap, or may be wider than the normal recording band gap. In some examples, the shingled/normal recording band gap may be substantially the same as the shingled recording band gap, may be narrower than the shingled recording band gap, or may be wider than the shingled recording band gap.

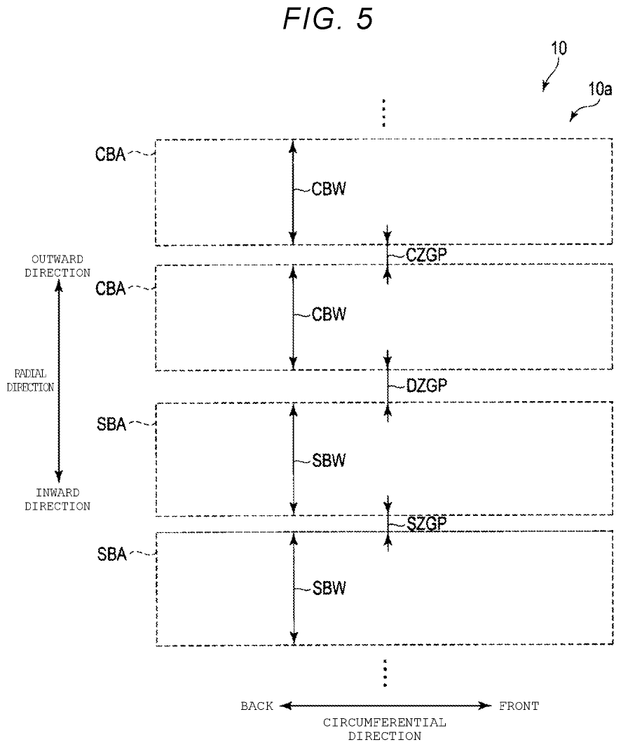

FIG. 5 is a schematic diagram illustrating the arrangement of the normal recording band area CBA and the shingled recording band area SBA. FIG. 5 illustrates a width CBW (also referred to as a normal recording bandwidth) of the normal recording band area CBA in the radial direction and a width SBW (also referred to as a shingled recording bandwidth) of the shingled recording band area SBA in the radial direction. For example, the normal recording bandwidth CBW and the shingled recording bandwidth SBW are the same or substantially so. In other examples, the normal recording bandwidth CBW and the shingled recording bandwidth SBW may be different from one another. Also, for example, the area of the normal recording band area CBA is substantially the same as the area of the shingled recording band area SBA. However, in some examples, the area of the normal recording band area CBA and the area of the shingled recording band area SBA may be different.

FIG. 5 illustrates a normal recording band gap CZGP, a shingled recording band gap SZGP, and a shingled/normal recording band gap DZGP. For example, the shingled/normal recording band gap DZGP is larger than the normal recording band gap CZGP and the shingled recording band gap SZGP. For example, the shingled recording band gap SZGP is larger than the normal recording band gap CZGP. In FIG. 5, for convenience of description, the normal recording band area CBA and the shingled recording band area SBA are illustrated as a rectangular shape extending in the circumferential direction, but actually, these areas/regions are curved along the circumferential direction.

The recording area management unit 620 sets or arranges two normal recording band areas CBA to be in the user data area 10a adjacent to one another in the radial direction at the normal recording band gap CZGP distance apart. The recording area management unit 620 also sets or arranges two shingled recording band areas SBA adjacent to one another in the radial direction at the shingled recording band gap SZGP distance apart in the user data area 10a. The recording area management unit 620 further sets or arranges the normal recording band area CBA and the shingled recording band area SBA that are adjacent to one another in the user data area 10a in the radial direction to be the shingled/normal recording band gap DZGP apart in distance from one another.

In the user data area 10a, the recording area management unit 620 may can arrange a normal recording band area CBA, a shingled recording band area SBA, and then another normal recording band area CBA at the shingled/normal recording band gap DZGP in the stated order along the radial direction.

In the user data area 10a, the recording area management unit 620 may arrange the shingled recording band area SBA, the normal recording band area CBA, and the shingled recording band area SBA with the shingled/normal recording band gap DZGP in the stated order in the radial direction.

The write retry control unit 630 performs a write retry operation for rewriting the same data to a particular area (also this is referred to as a write retry, write retry processing, or retry processing), for example, the particular area is the same area for which it was previously attempted to be written with data when the data write processing to a particular track was not successfully completed. The write retry control unit 630 counts the number of times the write retry processing has been executed (hereinafter, this count may be referred to as the number of retries) on a particular area, for example, a particular track. The write retry control unit 630 sets an upper limit value (hereinafter, this value may be referred to as a retry threshold) for the number of times write retry processing can be executed on such a particular area. The write retry control unit 630 records retry thresholds as a table in a predetermined area, for example, the system area 10c of the disk 10, the nonvolatile memory 80, or the like.

The write retry control unit 630 sets a retry threshold for each of the normal recording band area CBA and the shingled recording band area SBA.

The write retry control unit 630 sets a retry threshold in the shingled recording band area SBA. The write retry control unit 630 sets a retry threshold (hereinafter, may be referred to as a shingled recording retry threshold) for each track in the shingled recording band area SBA and a retry threshold (hereinafter, this may be referred to as a shingled recording area threshold) corresponding to the total number of retries of the write retry processing executed on all tracks in the shingled recording band area SBA. For example, the write retry control unit 630 sets the same shingled recording retry threshold for each track in the shingled recording band area SBA. The write retry control unit 630 may set a different shingled recording retry threshold for each track in the shingled recording band area SBA.

In the shingled recording processing, since a plurality of tracks partially overlap, the leakage (hereinafter, may by referred to as fringing or fringe) of the recording magnetic field from the write head 15W has a large effect. Therefore, the write retry control unit 630 limits, for example, the shingled recording retry threshold to a small value. The write retry control unit 630 records a shingled recording retry threshold for each track of the shingled recording band area SBA and a shingled recording area threshold for the shingled recording band area SBA as a table in a predetermined area, for example, the system area 10c of the disk 10, the nonvolatile memory 80, or the like.

The write retry control unit 630 sets a retry threshold for the normal recording band area CBA. The write retry control unit 630 sets a retry threshold (hereinafter, this may be referred to as a normal recording retry threshold) for each track of the normal recording band area CBA. For example, the write retry control unit 630 sets the same normal recording retry threshold for each track in the normal recording band area CBA. The write retry control unit 630 may set a different normal recording retry threshold for each track in the normal recording band area CBA. Since the track pitch TRP of a plurality of tracks on which normal recording is performed is larger than the track pitch WTP of a plurality of tracks on which shingled recording is performed, the influence of the fringe from the write head 15W is smaller in the normal recording processing than in the shingled recording processing. Therefore, the write retry control unit 630 sets the normal recording retry threshold to a value larger than a shingled recording retry threshold. That is, the normal recording retry threshold is larger than the shingled recording retry threshold. In addition, the write retry control unit 630 may set a retry threshold (hereinafter, this may be referred to as a normal recording area threshold) corresponding to the total number of retries for the normal recording band area CBA. The write retry control unit 630 records a normal recording retry threshold for each track of the normal recording band area CBA as a table in a predetermined area, for example, the system area 10c of the disk 10, the nonvolatile memory 80, or the like.

The write retry control unit 630 sets a plurality of retry thresholds in the normal recording band area (hereinafter, may be referred to as a limited normal recording band area) CBA adjacent to the shingled recording band area SBA. In the limited normal recording band area CBA, the write retry control unit 630 sets different retry thresholds for a limited number of tracks (hereinafter, such a track may be referred to as a limited track) arranged on the side of the shingled recording band area SBA and for tracks other than the limited track(s) (hereinafter, these other tracks may be referred to as non-limited track(s)).

In the limited normal recording band area CBA, the write retry control unit 630 sets a predetermined limited number of tracks arranged in a radial direction (also referred to in this context as a separated direction for simplicity) opposite to the shingled recording band area SBA from a track (hereinafter, this track may be referred to as a near track or nearest track) for writing user data closest to the shingled recording band area SBA, as limited tracks.

For example, in the limited normal recording band area CBA, the write retry control unit 630 sets the limited number of tracks equal to or less than the tracks arranged in a range corresponding to one-half the radial width of the limited normal recording band area in the radial direction from a near track as limited tracks. This range may be referred to as a radial range and may be considered to have a bandwidth that is referred to as a limited bandwidth. For example, in the limited normal recording band area CBA, the write retry control unit 630 sets the limited number of tracks from a near track to the track most distant from the shingled recording band area SBA in which wide area track erase (WATE) and fringe might be expected to affect tracks in the shingled recording band area SBA, as the limited tracks.

In other words, in the limited normal recording band area CBA, the write retry control unit 630 may set the limited number of tracks to be those tracks arranged within a range in which WATE, fringe, and the like affect tracks in the shingled recording band area SBA, as the limited tracks.

The write retry control unit 630 sets all the tracks in the limited normal recording band area CBA, which is, for example, a few percent to several tens of percent (for example, 10%) of a total of hundreds of tracks in the shingled recording band area SBA to be the limited tracks. For example, the write retry control unit 630 can set, adjust, or change the limited number of tracks according to design parameters of the head 15, disk 10, the recording density (for example, tracks per inch (TPI) and bits per inch (BPI)) of the disk 10, the distance from the shingled recording band area SBA, the shingled/normal recording band gap, the shingled recording area threshold, and/or the shingled recording retry threshold, and the like.

In the limited normal recording band area CBA, the write retry control unit 630 may set a radial area up to a radial position separated by a predetermined distance in the separated direction from a radial end/edge of the limited normal recording band area CBA on the side of the shingled recording band area SBA, as a limited area for setting a different retry threshold from the retry threshold of a non-limited area, and may set some predetermined number of tracks in the limited area as limited tracks.

The width (hereinafter, this may be referred to as a limited area width) of the limited area in the radial direction is, for example, equal to or less than half of the limited bandwidth. For example, in the limited normal recording band area CBA, the write retry control unit 630 may set a radial area of a range in which the WATE, the fringe, and the like affect tracks in the shingled recording band area SBA, as a limited area, and may set a predetermined number of tracks arranged in the limited area as limited tracks.

For example, the write retry control unit 630 can set a limited area according to the head 15 and the disk 10, the recording density (for example, TPI and BPI) of the disk 10, the distance from the shingled recording band area SBA, the shingled/normal recording band gap, the shingled recording area threshold, and/or the shingled recording retry threshold, and the like.

In the limited normal recording band area CBA, the write retry control unit 630 sets a retry threshold for a limited track and a normal recording retry threshold for an non-limited track. For example, the write retry control unit 630 sets the same retry threshold (referred to here as limited retry threshold) for each limited track in the limited normal recording band area CBA. In some examples, the write retry control unit 630 may set a different limited retry threshold for each limited track in the limited normal recording band area CBA. The limited retry threshold is smaller than the normal recording retry threshold, for example, the limited retry threshold can be the same as the shingled recording retry threshold.

For example, the write retry control unit 630 sets the same normal recording retry threshold for each non-limited track in the limited normal recording band area CBA. In some examples, the write retry control unit 630 may set a different normal recording retry threshold for each non-limited track in the limited normal recording band area CBA.

The write retry control unit 630 records a limited retry threshold for each limited track in the limited normal recording band area CBA and a normal recording retry threshold for each non-limited track in the limited normal recording band area CBA in a table in, for example, the system area 10c of the disk 10, the nonvolatile memory 80, or the like.

When the number of retries exceeds the retry threshold in a predetermined area, that is, when the number of retries is greater than the retry threshold, the write retry control unit 630 executes: defect processing for registering the area as a defective area; processing (referred to as save processing or slip processing) for saving data to be written to this potentially defective area to another predetermined area (hereinafter, this other area may be referred to as a save area or a slip area); or retry threshold change processing of changing the retry threshold for this potentially defective area, and the like.

For example, when the number of retries in a certain track in the normal recording band area CBA exceeds the normal recording retry threshold, the write retry control unit 630 registers this track as a defective track in a running list, a G (grown) list (“G list”), or the like recorded in the system area 10c, and executes the next write processing.

For example, when the number of retries in a certain track in the shingled recording band area SBA exceeds the shingled recording retry threshold, the write retry control unit 630 saves data to be written in this track, in a save area for each data to be written to each sector of this track. Such a save area is provided, for example, in the shingled band area SBA. The save area may be provided in the media cache 10b or the like. Further, in this context, the term “save” includes the meaning of “write (record)”, “move to another area”, or “temporarily record”.

When the number of retries in a certain track in the shingled recording band area SBA exceeds the shingled area retry threshold, and when all data to be written to this track cannot be saved in the save area, the write retry control unit 630 saves the remaining data other than the data saved in the save area in the data to be written to this track to the media cache 10b. When the slip processing (or the save processing) repeatedly occurs in a particular track of the shingled recording band area SBA, the write retry control unit 630 registers this track as a defective track in the G list or the like recorded in the system area 10c, and executes the next write processing. Further, for example, when the total number of retries in the shingled recording band area SBA exceeds the shingled recording area threshold, the write retry control unit 630 reduces the shingled recording retry threshold and/or the shingled recording area threshold of all tracks in the shingled recording band area SBA.

For example, when the number of retries in a certain non-limited track exceeds the limited normal recording retry threshold in the limited normal recording band area CBA, the write retry control unit 630 registers this non-limited track as a defective track in the G list or the like recorded in the system area 10c, and executes the next write processing. For example, when the number of retries in a certain limited track in the limited normal recording band area CBA exceeds the limited retry threshold, the write retry control unit 630 saves data to be written to the limited track in the save area for each data to be written to each sector of the limited track. A save area is provided, for example, in the limited normal recording band area CBA. The save area may be provided in the media cache 10b or the like.

When the number of retries in a certain limited track in the limited normal recording band area CBA exceeds the limited retry threshold, and when all data to be written to this limited track cannot be saved in the save area, the write retry control unit 630 saves the remaining data other than the data saved in the save area in the data to be written to this limited track to the media cache 10b. When the slip processing (or the save processing) repeatedly occurs in a certain limited track of the limited normal recording band area CBA, the write retry control unit 630 registers this limited track as a defective track in the G list or the like registered in the system area 10c, and executes the next write processing.

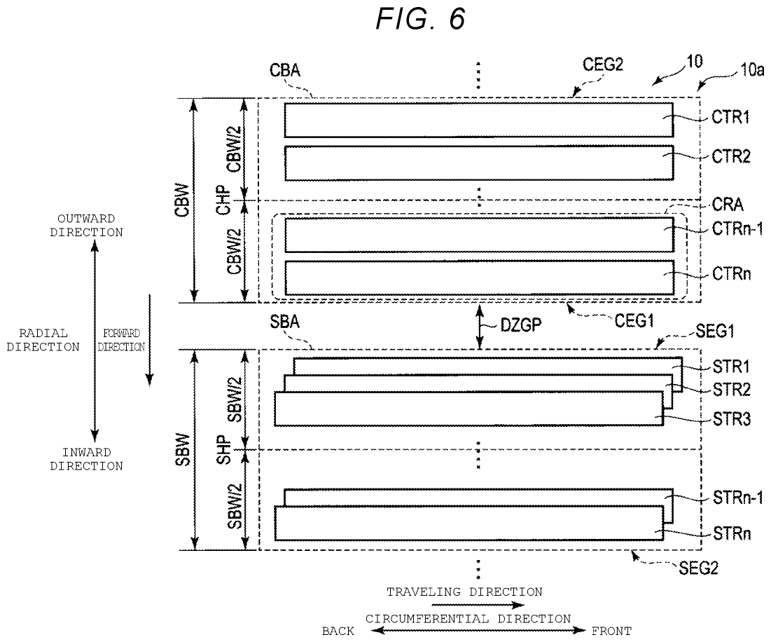

FIG. 6 is a schematic diagram illustrating a method of setting a limited track. FIG. 6 illustrates the limited normal recording band area CBA and the shingled recording band area SBA. In FIG. 6, the limited normal recording band area CBA corresponds to the normal recording band area CBA illustrated in FIG. 3, and the shingled recording band area SBA corresponds to the shingled recording band area SBA illustrated in FIG. 4.

In FIG. 6, the limited normal recording band area CBA and the shingled recording band area SBA are separated in the radial direction by the shingled/normal recording band gap DZGP. In FIG. 6, the limited normal recording band area CBA is separated from the shingled recording band area SBA outward by the shingled/normal recording band gap DZGP. In other words, the shingled recording band area SBA is separated by the limited normal recording band area CBA inward by the shingled/normal recording band gap DZGP.

FIG. 6 illustrates the limited bandwidth CBW of the limited normal recording band area CBA. The limited bandwidth CBW is, for example, the same as the normal recording bandwidth CBW. The limited bandwidth CBW may be different from the normal recording bandwidth CBW, for example. FIG. 6 illustrates a radial end CEG1 of the limited normal recording band area CBA on the side of the shingled recording band area SBA, a radial end CEG2 opposite to the radial end CEG1, a radial end SEG1 of the shingled recording band area SBA in a side of the limited normal recording band area CBA, and a radial end SEG2 opposite to the radial end SEG1. In FIG. 6, the radial end CEG1 and the radial end SEG1 face each other in the radial direction.

FIG. 6 illustrates a radial position CHP separated from the radial end portion CEG1 outward by a distance corresponding to CBW/2, half the limited bandwidth of the limited normal recording band area CBA, and a radial position SHP separated from the radial end portion SEG1 inward by a distance corresponding to SBW/2, half the shingled recording bandwidth of the shingled recording band area SBA. In FIG. 6, the limited normal recording band area CBA includes a limited area CRA. The limited area CRA corresponds to a radial area of the limited normal recording band area CBA, which is equal to or less than CBW/2, half the limited bandwidth from the radial end CEG1 to the radial position CHP. In FIG. 6, the limited area CRA includes, for example, the tracks CTRn and CTRn-1.

The write retry control unit 630 sets, for example, two tracks from the near track CTRn to the track CTRn-1 separated in the separated direction in the limited normal recording band area CBA, as limited tracks. The write retry control unit 630 sets, for example, the radial area CRA as the limited area CRA in the limited normal recording band area CBA, and sets the tracks CTRn and CTRn-1 arranged in the limited area CRA as limited tracks.

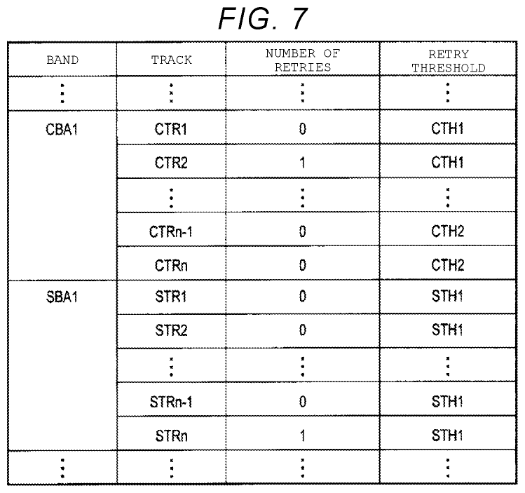

FIG. 7 is a diagram illustrating a table TB1 for storing the number of retries in each track. The table TB includes a band, a track, the number of retries for each track, and a retry threshold for each track. In the table TB, a band indicates the type of a band area and the identification number of the band area, a track indicates the type of a track and the identification number of the track, the number of retries indicates the number of times of write retry processing that has been performed in the track, and a retry threshold indicates a retry threshold for the track.

A normal recording band area CBA1 illustrated in the band of the table TB in FIG. 7 indicates the normal recording band area CBA with an identification number 1, and a shingled recording band area SBA1 illustrated in the table TB in FIG. 7 indicates the shingled recording band area SBA with an identification number 1. In the table TB of FIG. 7, the normal recording band area CBA1 and the shingled recording band area SBA1 are adjacent to each other on the disk 10. That is, the normal recording band area CBA1 corresponds to the limited normal recording band area CBA1. For example, the normal recording band area CBA1 illustrated in the table TB in FIG. 7 corresponds to the normal recording band area CBA illustrated in FIG. 6. Further, the shingled recording band area SBA1 illustrated in the table TB of FIG. corresponds to the shingled recording band area SBA illustrated in FIG. 6. In the limited normal recording band area CBA1 of the table TB in FIG. 7, the tracks CTR1 and CTR2 correspond to non-limited tracks, and the tracks CTRn-1 and CTRn correspond to limited tracks.

The retry threshold of the limited normal recording band area CBA1 in the table TB in FIG. 7 indicates a normal recording retry threshold CTH1 and a limited retry threshold CTH2. The retry threshold of the shingled recording band area SBA1 in the table TB of FIG. 7 indicates a shingled recording retry threshold STH1. For example, the limited retry threshold CTH2 and the shingled recording retry threshold STH1 are the same. The table TB does not have to include at least one of the band, the track, the number of retries for each track, and the retry threshold for each track and may include parameters other than the band, the track, the number of retries for each track, and the retry threshold for each track.

In the example illustrated in FIG. 7, the write retry control unit 630 sets the normal recording retry threshold CTH1 for the non-limited tracks CTR1, CTR2, in the limited normal recording band area CBA1. Further, the write retry control unit 630 sets the limited retry threshold CTH2 for the limited tracks CTRn-1 and CTRn in the limited normal recording band area CBA1.

In the example illustrated in FIG. 7, when the number of retries in the non-limited track CTR1 exceeds the normal recording retry threshold CTH1 for the limited normal recording band area CBA1, the write retry control unit 630 registers the non-limited track CTR1 as a defective track in the G list or the like recorded in the system area 10c and proceeds with the next write processing.

In the example illustrated in FIG. 7, when the number of retries in the non-limited track CTR2 exceeds the normal recording retry threshold CTH1 for the limited normal recording band area CBA1, the write retry control unit 630 registers the non-limited track CTR2 as a defective track in the G list or the like recorded in the system area 10c and proceeds with the next write processing.

In the example illustrated in FIG. 7, when the number of retries in the limited track CTRn-1 in the limited recording band area CBA exceeds the limited retry threshold, the write retry control unit 630 saves data to be written to the limited track in the save area for each data to be written to each sector of the limited track CTRn-1. When the number of retries in the limited track CTRn-1 exceeds the limited retry threshold CTH2 in the limited normal recording band area CBA, and when all data to be written to the limited track CTRn-1 cannot be saved in the save area, the write retry control unit 630 saves the remaining data other than the data saved in the save area in the data to be written to the limited track CTRn-1 to the media cache 10b. When the slip processing has repeatedly been performed in the limited track CTRn-1, the write retry control unit 630 registers the limited track CTRn-1 as a defective track in the G list or the like registered in the system area 10c and executes the next write processing.

In the example illustrated in FIG. 7, when the number of retries in the limited track CTRn in the limited normal recording band area CBA exceeds the limited retry threshold, the write retry control unit 630 saves data to be written to the limited track CTRn in the save area for each sector of data to be written to the limited track CTRn. When the number of retries in the limited track CTRn exceeds the limited retry threshold CTH2 in the limited normal recording band area CBA, and when all data to be written to the limited track CTRn cannot be saved in the save area, the write retry control unit 630 saves the remaining data other than the data saved in the save area in the data to be written to the limited track CTRn to the media cache 10b. When the slip processing has repeatedly been performed in the limited track CTRn, the write retry control unit 630 registers the limited track CTRn as a defective track in the G list or the like registered in the system area 10c and executes the next write processing.

When the number of retries in a certain area exceeds the retry threshold, the refresh control unit 640 executes processing (hereinafter, this processing may be referred to as refresh processing) of reading data written in an area within a predetermined radial range from the certain area, and rewriting the data in the same area.

For example, when the number of retries exceeds the normal recording retry threshold in a certain track of the normal recording band area CBA, the refresh control unit 640 executes refresh processing on some tracks arranged in the radial direction from the certain track.

For example, when the number of retries in the non-limited track of the limited normal recording band area CBA exceeds the normal recording retry threshold, the refresh control unit 640 executes refresh processing on some tracks arranged in the radial direction from the non-limited track. For example, when the number of retries in the limited track of the limited normal recording band area CBA exceeds the limited retry threshold, the refresh control unit 640 executes refresh processing on some tracks arranged in the radial direction from the limited track and on the shingled recording band area SBA.

For example, when the number of retries in a certain track in the shingled recording band area SBA exceeds the shingled recording retry threshold, the refresh control unit 640 executes refresh processing on all tracks of the shingled recording band area. In other words, when the number of retries in a certain track of the shingled recording band area exceeds the shingled recording retry threshold, the refresh control unit 640 rewrites the shingled recording band area.

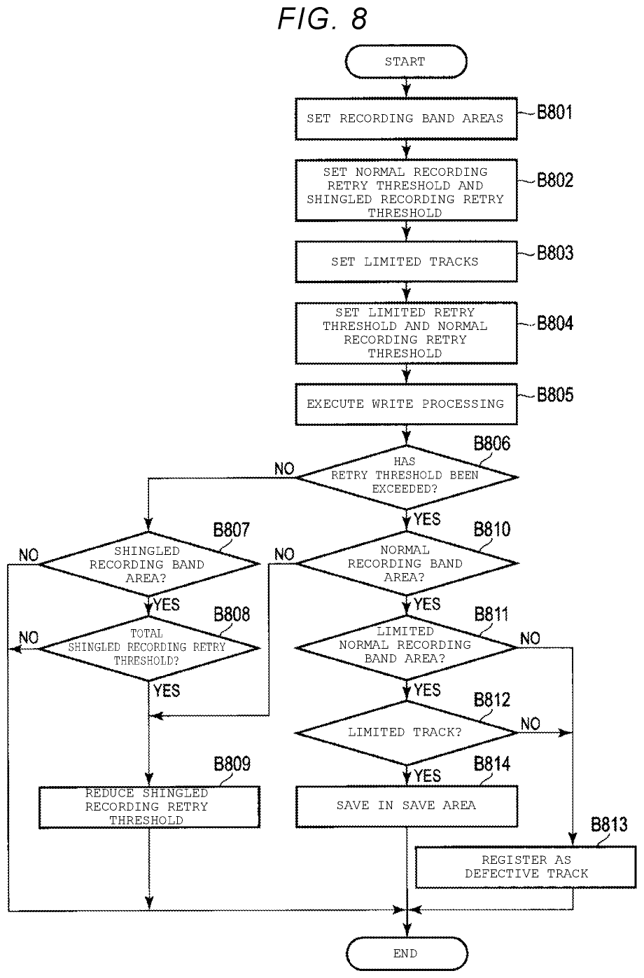

FIG. 8 is a flowchart of the write retry processing according to the present embodiment.

The system controller 130 sets the normal recording band area CBA and the shingled recording band area SBA in the user data area 10a (B801). For example, the system controller 130 sets two normal recording band areas CBA that are adjacent in the radial direction with the normal recording band gap, arranges two shingled recording band areas SBA that are adjacent in the radial direction with the shingled recording band gap therebetween, and arranges a shingled recording band area SBA and a normal recording band area) CBA (which in this context, is referred to as a limited normal recording band area CBA) that are adjacent in the radial direction with the shingled/normal recording band gap therebetween.

The system controller 130 sets a normal recording retry threshold for each track in the normal recording band area CBA, and sets a shingled recording retry threshold for each track in the shingled recording band area SBA (B802). In the limited normal recording band area CBA, the system controller 130 sets some tracks arranged on the side nearer the shingled recording band area SBA as limited tracks (B803). For example, the system controller 130 sets the limited number of tracks from a few percent to several tens of percent of the number of all tracks of the limited normal recording band area CBA as limited tracks.

In the limited normal recording band area CBA, the system controller 130 sets a limited retry threshold for the limited tracks and sets a normal recording retry threshold for the non-limited tracks (B804).

The system controller 130 executes write processing (B805). For example, the system controller 130 executes write processing on a certain area of the shingled recording band area SBA, the normal recording band area CBA, or the limited normal recording band area CBA, for example, a certain track. The system controller 130 determines whether the number of retries in the certain track has exceeded the retry threshold (B806).

For example, the system controller 130 determines whether the number of retries in a certain track in the shingled recording band area SBA exceeds the shingled recording retry threshold. For example, the system controller 130 determines whether the number of retries in a certain track in the normal recording band area CBA exceeds the normal recording retry threshold. For example, the system controller 130 determines whether the number of retries in a certain limited track in the limited normal recording band area CBA exceeds the limited retry threshold. For example, the system controller 130 determines whether the number of retries in a certain non-limited track in the limited normal recording band area CBA exceeds the normal recording retry threshold.

When it is determined that the number of retries in the certain track does not exceed the retry threshold (NO in B806), the system controller 130 determines whether the band area in which the write processing is being executed is the shingled recording band area SBA (B807). In other words, when it is determined that the number of retries in the certain track does not exceed the retry threshold, the system controller 130 determines whether the band area where the write processing is being executed is the shingled recording band area SBA or the normal recording band area CBA. When it is determined that the band area where the write processing is being executed is not the shingled recording band area SBA, that is, the band area where the write processing is being executed is the normal recording band area CBA (NO in B807), the system controller 130 ends the processing.

When it is determined that the band area where the write processing is being executed is the shingled recording band area SBA (YES in B807), the system controller 130 determines whether the total number of retries in the shingled recording band area SBA exceeds the shingled recording area threshold (B808). When it is determined that the total number of retries in the shingled recording band area SBA does not exceed the shingled recording area threshold (NO in B808), the system controller 130 ends the processing. When it is determined that the total number of retries in the shingled recording band area SBA exceeds the shingled recording area threshold value (YES in B808), the system controller 130 reduces the shingled recording retry threshold for the certain track in the shingled recording band area SBA (B809), and ends the processing.

When it is determined that the number of retries in the certain track exceeds the retry threshold (YES in B806), the system controller 130 determines whether the band area in which the write processing is being executed is the normal recording band area CBA (B810). In other words, when it is determined that the number of retries in the certain track exceeds the retry threshold, the system controller 130 determines whether the band area where the write processing is being executed is the shingled recording band area SBA or the normal recording band area CBA.

When it is determined that the band area where the write processing is being executed is not the normal recording band area CBA, that is, the band area where the write processing is being executed is the shingled recording band area SBA (NO in B810), the system controller 130 proceeds to the processing of B809. When it is determined that the band area where the write processing is being executed is the normal recording band area CBA (YES in B810), the system controller 130 determines whether the band area is the limited normal recording band area CBA (B811). When it is determined that the band area is not the limited normal recording band area CBA (NO in B811), the system controller 130 proceeds to the processing of B813. When it is determined that the band area is the limited normal recording band area CBA (YES in B811), the system controller 130 determines whether the track on which the write processing is being executed is a limited track (B812). In other words, when it is determined that the band area is the limited normal recording band area CBA, the system controller 130 determines whether the track on which the write processing is being executed is a limited track or a non-limited track. When it is determined that the track on which the write processing is being executed is not the limited track, that is, the track on which the write processing is being executed is the non-limited track (NO in B812), the system controller 130 registers this non-limited track as a defective track, for example, the G list (B813) and ends the processing.

On the other hand, when it is determined that the track on which the write processing is being executed is a limited track (YES in B812), the system controller 130 saves the data in the save area for data of each sector of this limited track (B814), and ends the processing. For example, when the number of retries in a limited track in the limited normal recording band area CBA exceeds the limited retry threshold, and when all data to be written to this limited track cannot be saved in the save area, the system controller 130 saves the remaining data other than the data saved in the save area in the data to be written to this limited track to the media cache 10b, and end the processing. Further, for example, when slip processing has been repeatedly performed in a particular limited track in the limited normal recording band area CBA, the system controller 130 registers this limited track as a defective track in the G list or the like stored in the system area 10c, and ends the processing.

According to the aforementioned embodiments, the magnetic disk device 1 sets a normal recording band area and/or a shingled recording band area, in the user data area 10a. The magnetic disk device 1 arranges the shingled recording band area SBA to be next to a normal recording band area CBA in the radial direction with the shingled/normal recording band gap therebetween. This otherwise normal recording band area CBA is handled as a limited normal recording band area due to its adjacency to a shingled recording band area SBA. The magnetic disk device 1 treats some tracks arranged on the side of the limited normal recording band area CBA nearest the shingled recording band area SBA as so called “limited tracks.” The magnetic disk device 1 sets a limited retry threshold for such a limited track (or tracks) in the limited normal recording band area CBA, and sets a normal recording retry threshold for the non-limited track(s) in the limited normal recording band area CBA.

When the number of retries in a certain non-limited track in the limited normal recording band area CBA exceeds the normal recording retry threshold, the system controller 130 registers the certain track as a defective track in a predetermined area, for example, the G list. When the number of retries in a certain track in the limited normal recording band area CBA exceeds the limited retry threshold, the system controller 130 saves the data in the save area for data of each sector of the certain limited track. The magnetic disk device 1 can thus reduce data losses/erasures due to the influence of WATE, fringe, and the like on some tracks on the side near the shingled recording band area SBA by preventing repetition of the write retry processing in some limited tracks on the side of the shingled recording band area SBA in the limited normal recording band area CBA. Therefore, the magnetic disk device 1 can reduce the frequency of the refresh processing, and can improve performance. In the magnetic disk device 1, the shingled recording band area SBA and the normal recording band area CBA can be arranged relatively close to each other in the radial direction. Therefore, the magnetic disk device 1 can increase the data capacity that can be written to the disk 10. Therefore, the magnetic disk device 1 can improve the performance of the write processing.

Next, a magnetic disk device according to a modification example will be described. In the modification example, the same parts as those in the above-described embodiments are denoted by the same reference numerals, and detailed description thereof will be omitted.

### MODIFICATION EXAMPLE

The magnetic disk device 1 according to the modification example is different from the magnetic disk device 1 of the first embodiment in that the magnetic disk device 1 includes a save area in a band area.

Each of the normal recording band area CBA and the shingled recording band area SBA includes a save area. For example, the normal recording band area CBA and the shingled recording band area SBA each include a save area at a forward end. The media cache 10b may include a save area.

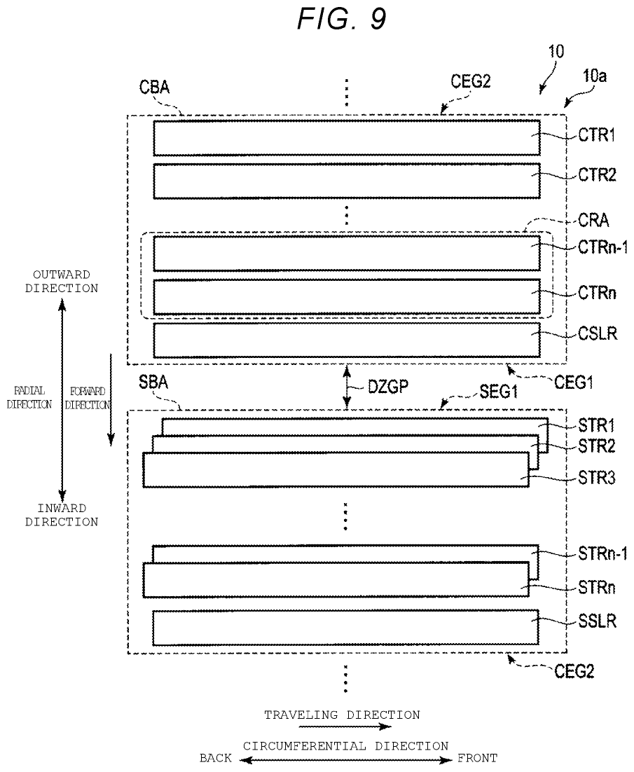

FIG. 9 is a schematic diagram illustrating the normal recording band area CBA and the shingled recording band area SBA according to the modification example. In the example illustrated in FIG. 9, the normal recording band area CBA includes a save area CSLR. The save area CSLR is arranged, for example, at the forward end of the normal recording band area CBA. In FIG. 9, the save area CSLR is arranged between the radial end CEG1 and the limited track (i.e., near track) CTRn. That is, in FIG. 9, the save area CSLR is arranged in the normal recording band area CBA in the area closest to the shingled recording band area SBA.

In the example illustrated in FIG. 9, the save area CSLR corresponds to an area for one track. The save area CSLR may be an area smaller than the area for one track, or may be an area larger than the area for one track. In the example illustrated in FIG. 9, the shingled recording band area SBA includes a save area SSLR. The save area SSLR is arranged, for example, at the forward end of the shingled recording band area SBA. In FIG. 9, the save area SSLR is arranged between the radial end SEG2 and the track STRn. The save area SSLR may partially overlap with the track STRn.

In the example illustrated in FIG. 9, the save area SSLR corresponds to an area for one track. However, the save area SSLR in other examples may be an area smaller than the area for one track, or may be an area larger than the area for one track. For example, the save area SSLR can be larger than the save area CSLR. That is, the data capacity that can be written to the save area SSLR is larger than the data capacity that can be written to the save area CSLR. In other examples, the save areas CSLR and SSLR may be the same size/capacity. Furthermore, in still other examples, the save area SSLR may be smaller in size/capacity than the save area CSLR.

In the example illustrated in FIG. 9, when the number of retries in the track STRn in the shingled recording band area SBA exceeds the shingled recording retry threshold, the write retry control unit 630 saves data to be written to the track STRn in the save area SSLR for each data to be written to each sector of the track STRn. When the number of retries in the track STRn exceeds the shingled area retry threshold in the shingled recording band area SBA, and when all data to be written to the track STRn cannot be saved in the save area SSLR, the write retry control unit 630 saves the remaining data other than the data saved in the save area SSLR in the data to be written to the track STRn to the media cache 10b.

In the example illustrated in FIG. 9, when the number of retries in the limited track CTRn in the limited normal recording band area CBA exceeds the limited retry threshold, the write retry control unit 630 saves data to be written to the limited track CTRn in the save area CSLR for each data to be written to each sector of the limited track CTRn. When the number of retries in the limited track CTRn exceeds the limited retry threshold in the limited normal recording band area CBA, and when all data to be written to the limited track CTRn cannot be saved in the save area CSLR, the write retry control unit 630 saves the remaining data other than the data saved in the save area CSLR in the data to be written to the limited track CTRn to the media cache 10b.

According to the modification example, when the number of retries in a limited track in the limited normal recording band area CBA exceeds the limited retry threshold, the magnetic disk device 1 saves data to be written to this track in the save area CSLR for each data to be written to each sector of this limited track. The save area CSLR is provided, for example, at the forward end of the limited normal recording band area CBA. Therefore, the magnetic disk device 1 can improve the performance of the write processing.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A magnetic disk device, comprising:
a disk that includes a first area in which data is written by first recording technique such that a plurality of tracks are separated from each other, and a second area and in which data is written by second recording technique such that adjacent tracks partially overlap;
a head; and
a controller configured to:
control the head to write data to a track of the first or the second area by the first or the second recording technique, and
perform a retry operation when the data has not been written to the track successfully, and repeat the retry operation for the track until the data is written successfully to the track or up to a predetermined number of times, whichever comes first, wherein
when data is being written to a track of the first area, the predetermined number of times for the retry operation varies depending on a location of the track within the first area.

2. The magnetic disk device according to claim 1, wherein
the first area includes a first sub-area and a second sub-area farther from the second area than the first sub-area, and
when data is being written to a track in the first sub-area, the predetermined number of times is a first number, and when data is being written to a track in the second sub-area, the predetermined number of times is a second number different from the first number.

3. The magnetic disk device according to claim 2, wherein the first number is less than the second number.

4. The magnetic disk device according to claim 2, wherein the controller is further configured to control the head to write the data to another track when the retry operation to the track of the first sub-area has been repeated the first number of times and the data has still not been written successfully.

5. The magnetic disk device according to claim 4, wherein the first area includes a third sub-area including the said another track.

6. The magnetic disk device according to claim 4, wherein the second area includes the said another track.

7. The magnetic disk device according to claim 5, wherein
the disk includes a cache area in which data is temporarily stored, and
the controller is further configured to store at least part of the data in the cache area if the data has not yet been written to the said another track successfully.

8. The magnetic disk device according to claim 4, wherein
the disk includes a cache area in which data is temporarily stored, and
the controller is further configured to control the head to write the data to the cache area if the retry operation to the track of the first sub-area has been repeated the first number of times but the data has still not been written successfully.

9. The magnetic disk device according to claim 2, wherein the controller is further configured to register the track as a defective track if the retry operation to the track of the second sub-area has been repeated the second number of times but the data has still not been written successfully.

10. The magnetic disk device according to claim 2, wherein, when data is being written to a track of the second area, the retry operation is repeated up to the second number of times.

11. A method for writing data to a magnetic disk that includes a first area, in which data is written by first recording technique such that a plurality of tracks are spaced from each other, and a second area, in which data is written by second recording technique such that adjacent tracks partially overlap, the method comprising:
writing data to a track of the first or the second area by the first or the second recording technique; and
performing a retry operation if the data has not yet been written to the track successfully, and repeating the retry operation up to a predetermined number of times for the track or until the data is written successfully to the track, wherein
when the track is in the first area, the predetermined number of times for the track varies depending on the location of the track within the first area.

12. The method according to claim 11, wherein
the first area includes a first sub-area and a second sub-area farther from the second area than the first sub-area,
when data is being written to a track in the first sub-area, the predetermined number of times is a first number, and
when data is being written to a track in the second sub-area, the predetermined number of times is a second number different from the first number.

13. The method according to claim 12, wherein the first number is less than the second number.

14. The method according to claim 12, further comprising:
writing the data to another track when the retry operation to the track of the first sub-area has been repeated the first number of times and the data has still not been written successfully to the track.

15. The method according to claim 14, wherein the first area includes a third sub-area including the said another track.

16. The method according to claim 14, wherein the second area includes the said another track.

17. The method according to claim 15, wherein
the disk includes a cache area in which data can be temporarily stored, and
the method further comprises storing at least part of the data in the cache area if the data has not yet been written to the said another track successfully.

18. The method according to claim 14, wherein
the disk includes a cache area in which data can be temporarily stored, and
the method further comprises writing the data to the cache area if the retry operation to the track of the first sub-area has been repeated the first number of times and the data has still not been written successfully to the track.

19. The method according to claim 12, further comprising:
registering the track as a defective track when the retry operation to the track of the second sub-area has been repeated the second number of times and the data has still not been written successfully to the track.

20. The method according to claim 12, wherein the retry operation is repeated up to the second number of times when data is being written to a track in the second area.
